(19) United States
(12) Patent Application Publication
(10) Pub. No.: US 2013/0041587 A1
(43) Pub. Date: Feb. 14, 2013

(54) Using polymer elasticity to scale up the lab characteristics to field application of friction reducers

(71) Applicants: Ahmed Mohamed Mohamed Gomaa, Houston, TX (US); Jia Zhou, (US); Hong Sun, Houston, TX (US); Qi Qu, Houston, TX (US)

(72) Inventors: Ahmed Mohamed Mohamed Gomaa, Houston, TX (US); Jia Zhou, (US); Hong Sun, Houston, TX (US); Qi Qu, Houston, TX (US)

(73) Assignee: Baker Hughes Incorporated, Houston, TX (US)

(21) Appl. No.: 13/562,030

(22) Filed: Jul. 30, 2012

Related U.S. Application Data
(60) Provisional application No. 61/521,019, filed on Aug. 8, 2011.

(51) Int. Cl. G06F 19/00

(52) U.S. Cl. 702/6

(57) ABSTRACT

A method of determining the friction pressure drop gradient of at least one drag-reducing polymer passing through a tubing in an underground well includes determining the pressure drop, velocity and relaxation time of the drag-reducing polymer as it passes through a length of small diameter straight tubing at multiple injection rates in the lab. For each data set, the variables x=(Relaxation Time×Velocity) and y=(Pressure Drop Gradient×Diameter⁴×(1+De²)^{1.5}) are calculated, wherein De is the Deborah number. Each x, y data point is plotted on a graph where the x-axis represents (Relaxation Time×Velocity) and the y-axis represents (Pressure Drop Gradient×Diameter⁴×(1+De²)^{1.5}), wherein the curve formed by the plotted data approximates the x and y data for the drag-reducing polymer as it passes through the tubing in the underground well.

This application claims the benefit of U.S. patent application Ser. No. 61/521,019, filed on Aug. 8, 2011, herein incorporated by reference.

### FIELD OF THE INVENTION

The present disclosure relates generally to a method of predicting the behavior of polymers used in well treatment operations. In some embodiments, the present disclosure relates to predicting the behavior of drag-reducing polymers used in slickwater fracturing treatments.

### BACKGROUND OF THE INVENTION

Current hydraulic fracturing techniques used in the oil and gas industry sometimes require or warrant the use of drag-reducing polymers. Such polymers have particular applicability in slickwater fracturing operations.

Slickwater fracturing is commonly used in stimulation treatments of tight and shale gas reservoirs. Slickwater fracturing involves pumping a low-viscosity fluid (typically fresh water) down the wellbore. In order to maintain proppant transport, rates of 120 bbl/min or higher may be required.

The process typically requires friction reduction agents in order to reduce the frictional drag of turbulent flow of the pumped fluid. Turbulent forces the near-wall vortical structures become weaker, thicker, longer, and fewer in turbulence. This significantly reduces the frictional drag of the solution.

Thus, in a typical slickwater fracturing operation, friction reducers are injected into the reservoir in order to minimize pipe wall friction and reduce the surface horsepower that would otherwise be required to achieve high pump rates of the fluid.

Typically, friction reduction agents are large polymers with long polymer chain. They further tend to build non-Newtonian gel structures and are shear-sensitive. A copolymer of polyacrylamide emulsified in hydrotreated light petroleum distillates is the most widely used friction reduction agent in the field today. Emulsified polymers typically comprise water-in-oil emulsions of high-molecular-weight copolymers of acrylamide with different anionic monomers. In such emulsions, the active polymer is “packed” inside water droplets dispersed in the continuous oil phase. Upon contact with aqueous-based ambient fluid, emulsion polymers undergo what is commonly known as an “inversion process,” during which the high-molecular-weight polymer is released from the emulsion droplet into the ambient fluid. Turbulent friction is reduced when the polymer has migrated to the near-wall boundary layer, where its interaction with eddies of turbulence promotes the reduction of friction.

The prediction of friction losses produced by fluid injection down the wellbore is an important aspect of stimulation treatment design. Initially, these predictions are used to estimate injection horsepower requirements. Introduction of real-time treating pressure analysis places additional emphasis on the need for reliable friction loss estimates.

In Lord, D. L., “Turbulent Flow of Stimulation Fluids: An Evaluation of Friction Loss Scale-Up Methods”, SPE 16889 presented at Annual Technical Conference and Exhibition, Dallas, Tex., Sep. 27-30, 1987, the authors determined that nontrivial scale-up methods do not exist and that it is essential to determine unique, method-dependent parameters using turbulent flow pressure loss measurements obtained with the specific fluid formulation. (Each of the references described herein is incorporated by reference.)

Keck, R. G., Nehmer, W. L., and Strumolo, G. S., “A New Method for Predicting Friction Pressures and Rheology of Proppant-Laden Fracturing Fluids”, Journal SPE Production Engineering, 7(1):21-28, 1992) presented two correlations for predicting friction pressures for hydroxypropyl linear gels and delayed crosslinked hydroxypropyl guar fracturing fluid systems. The first correlation developed from field-sized yard tests with Prandtl's law of friction for turbulent Newtonian flow. The second correlation predicts the increased friction loss caused by proppant. Both equations avoided the problem of diameter scale-up.

In Webster, D. R. and Humphrey, J. A. C., “Experimental Observations of Flow Instability in a Helical Coil. Trans.”, ASME, 115-436, 1993, the authors proposed empirical friction factor formulas derived from experimental study in the turbulent flow regime for helical coil. Their correlation was limited to Newtonian fluids.

The tubular frictional pressure loss in straight and coiled tubing was experimentally investigated and reported in Azouz, I., Shah, S. N., Vinod, P. S., and Lord, D. L., “Experimental Investigation of Frictional Pressure Losses in Coiled Tubing”, Journal SPE Production & Facilities, 13(2): 91-96, 1998 where the authors found that tubing curvature had a significant effect on pressure losses. Also, for borate crosslinked hydroxypropyl guar systems, the pressure gradient was found to be dependent on both the pH of the fluid and the length of the coiled tubing, whereas for borate crosslinked guar gum systems, the pressure gradient was found to be a function of pH but not very sensitive to the length of tubing.

In Zamora, M., Roy, S., and Slater, K., “Comparing a Basic Set of Drilling Fluid Pressure-Loss Relationships to Flow-Loop and Field Data”, AADE Paper 05-NTCE-27 presented at National Technical Conference and Exhibition, Houston, Tex., Apr. 5-7, 2005), a basic set of equations was presented to calculate the frictional pressure losses for pipes and annuli. This set of equations applied to laminar, transitional, and turbulent flow of Herschel-Bulkley fluids, with Bingham-plastic and power-law behavior as special cases.

Friction reduction based on polymers is usually used at a concentration range from 0.5 to 1.75 gpt. See, Sun, H., Stevens, R. F., Cutler, J. L., Wood, B., Wheeler, R. S., and Qu, Q., “A Novel Nondamaging Friction Reducer: Development and Successful Slickwater Frac Applications”, Paper SPE 136807 presented at Tight Gas Completions Conference, San Antonio, Tex., Nov. 2-3, 2010; and Zhou, J., Sun, H., Stevens, R., Qu, Q., and Bai, B., “Bridging the Gap between Laboratory Characterization and Field Applications of Friction Reducers”, SPE 140942 presented at Production and Operations Symposium, Oklahoma City, Okla., Mar. 27-29, 2011. The low polymer concentration affects its rheological behavior in a way that does not follow Herschel-Bulkley or Bingham-plastic model fluids.

In Kamel, A. H., Shah, S. N., “Friction Pressure losses of surfactant-Based Fluids Flowing in Coiled Tubing”, SPE 135826 presented at Production and operation Conference and exhibition, Tunisia, Jun. 8-10, 2010, a new definition of Deborah number was used to predict the fanning friction factor. However, the reported technique did not show acceptable results in the prediction of field applications.

Cowan, M. E., Garner, C., Hiester, R. D., McCormick, C. L. 2001. Water Soluble Polymers. Correlation of Experimentally Determined Drag Reduction Efficiency and Extensional Viscosity of High Molecular Weight Polymers in Dilute Aqueous Solution. J. Applied Polymer Sci., 82:1222; Wagner, C. Amarouchene, Y., Doyle, P., and Bonn, D. 2003. Turbulent Drag Reduction of Polyelectrolyte Solutions: Relation with The Elongational Viscosity. Europhyslett. 64:823; Li, C-F., Sureshkumar, R., Khomami, B. 2006. Influence of Rheological Parameters on polymer Induced Turbulent Drag Reduction. J. Non-Newtonian Fluid Mech. 140:23; and Cunha, F. R., Andreotti, M. 2007. A Study of The Effect Of Polymer Solution In Promoting Friction Reduction In Turbulent Channel Flow. J. fluid Engineering.129:491 linked the performance of friction-reducing polymers with their rheological behavior in extensional flow fields, and especially their ability to reach an extended conformation and resist degradation of molecular weight due to the action of shear force.

Further, White, C. M., and Mungal, M. G. 2008.Mechanics and prediction of Turbulent Drag reduction with Polymers. Annu Rev. Fluid Mech., 40:235 reported that commonly used friction reducers cause friction reduction by interacting with eddies of turbulent flow. Their conclusions were consistent with Kim, K., Li, C-F., Sureshkumar, R., Balachandar, S., and Adrian, R. J. 2007, Effects of Polymer Stresses On Eddy Structures In Drag-Reduced Turbulent Channel Flow. Journal of Fluid Mechanics. 584:281-299. DOI: 10.1017/S0022112007006611; and Kim, K., Adrian, R., Balachandar, S., and Sureshkumar, R. 2008. Dynamics of Hairpin Vortices and Polymer-Induced Turbulent Drag Reduction. Phys. Rev. Lett., 100 who dynamically simulated the turbulent flow of water and found that near-wall vortical structures are closely related with production of Reynolds shear stress as shown in FIG. 1(a).

De Gennes, P. G. 1990 Introduction to Polymer Dynamics. Cambridge University Press confirmed that drag reduction does not come from a purely viscous effect of the dilute polymer solution because if the viscosity were a dominant parameter for drag reduction, the drag would decrease regardless of the polymer concentration.

Joseph, D. D. 1990. Fluid Dynamics of Viscoelastic Liquids.Springer showed that elasticity plays a predominant role in drag reduction (DR) where the coiling and stretching of flexible polymers in turbulent flow produces an elastic component in the polymer stress, as shown in FIG. 1(b). Since polymer elastic stresses can balance Reynolds shear stresses in a bulk turbulent flow at some scale and above some polymer concentration, drag may be reduced by intrinsic elastic counter-torques that retard the rotation of turbulent vortices.

Finally, Sreenivasan, K. R., and White, C. M. 2000. The Onset of Drag Reduction by Dilute Polymer Additives, and The Maximum Drag Reduction Asymptote. J. Fluid Mech. 409, 149-164 mentioned that polymer molecules absorb the small-scale turbulence energy into elastic energy and prohibit turbulence cascade, reducing drag. This makes the vortical structures in polymer solutions weaker, thicker, longer, and fewer, as shown in FIG. 1(c).

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the cited examples, features and/or disadvantages, merely because of the mention thereof herein.

There exists a need for improved methods for predicting the behavior of polymers used in well treatment operations. For instance, there exists a need to accurately predict the behavior in the lab of drag-reducing polymers in order to improve the performance of the drag-reducing polymers in the field. Since elasticity of drag-reducing polymers at turbulent conditions in a subterranean environment can force the near-wall vortical structures to become weaker, thicker, longer, fewer, or a combination thereof, frictional drag of the solution may be significantly reduced. A need exists for a keener understanding of the elastic characteristics of the polymers which may be accomplished by scaling up lab data relating to polymer elasticity of friction reducers for field applications.

### SUMMARY OF THE INVENTION

The behavior of a friction reduction polymer used in a well treatment operation of a subterranean formation, such as a fracturing operation, may be predicted from various parameters including polymer elasticity. Such polymers include drag-reducing polymers used in slickwater fracturing treatments.

In an embodiment, a mathematical model may be used to scale up the lab testing data to obtain the field pressure drop caused by typical oilfield concentrations of friction reduction polymers.

By using polymer elasticity, scale up lab characteristics to field applications of drag-reducing polymers employed in slickwater fracture treatments may be predicted.

In an embodiment, the friction pressure drop gradient of drag-reducing polymers used in tubing in a subterranean well may be predicted using rheological characteristics, tubing diameter and velocity as field data from lab testing.

In another embodiment, the friction pressure drop gradient of a drag-reducing polymer in straight tubing may be accurately predicted from lab tests on curved tubes (e.g., coiled tubing) using parameter(s) that eliminate the curvature effect of curved tubes (e.g. coiled tubing) for use in straight tubing in the field.

In an embodiment, the friction pressure drop gradient of at least one drag-reducing polymer passing through a tubing in an underground well may be determined by:
(a) conducting diameter flow loop tests and determining elastic modulus, G′, and viscous modulus, G″, of at least one drag-reducing polymer as the polymer passes through a straight tube having a defined inner diameter at at least three different injection rates and then determining the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}), wherein De is the Deborah number; and
(c) plotting each x, y data point on a graph where the x-axis represents (Relaxation Time×Velocity) and the y-axis represents (Pressure Drop Gradient×Diameter⁴×(1+De²)^{1.5}), wherein the curve formed by the plotted data approximates the x and y data for the drag-reducing polymer as it passes through the tubing in the underground well.

In another embodiment, the accurate prediction of the friction pressure drop gradient of at least one drag-reducing polymer passing through a straight tubing in an underground well may be made based upon lab results of testing conducted on curved tubing by:
(a) conducting small diameter flow loop tests and making elastic modulus, G′, and viscous modulus, G″, measurements of at least one drag-reducing polymer as the polymer passes through a curved tube having a defined inner diameter at at least three different injection rates to determine the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}×R^{0.22}), wherein De is the Deborah number, R is the curvature of the curved tube; and
(c) plotting each x, y data point on a graph where the x-axis represents (Relaxation Time×Velocity) and the y-axis represents (Pressure Drop Gradient×Diameter⁴×(1+De²)^{1.5}×R^{0.22}), wherein the curve formed by the plotted data approximates the x and y data for the drag-reducing polymer as it passes through the tubing in the underground well.

In another embodiment, the friction pressure drop gradient of at least one drag-reducing polymer passing through a tubing in an underground well may be determined by:
(a) conducting diameter flow loop tests and making elastic modulus, G′, and viscous modulus, G″, measurements of at least one drag-reducing polymer as the polymer passes through a straight tube having a defined inner diameter at at least three different injection rates to determine the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}), wherein De is the Deborah number;
(c) fitting the x and y values into the equation

$$Log ( y ) = \text{?} \frac{\text{?}}{\text{?}}$$

$$\text{?} \text{indicates text missing or illegible when filed}$$

to define the constants a and b; and
(d) fitting into the equation

$$Log ( y ) = a {e}^{\frac{b}{log ( x )}}$$

the defined values for the constants a and b along with field data for the variable x from the drag-reducing polymer passing through the tubing in the underground well to determine a corresponding value for y from which the friction pressure drop gradient of the drag-reducing polymer passing through the tubing in the underground well can be determined.

In another embodiment, the friction pressure drop gradient of at least one drag-reducing polymer passing through a tubing in an underground well may be determined by:
(a) conducting diameter flow loop tests and making elastic modulus, G′, and viscous modulus, G″, measurements of at least one drag-reducing polymer as the polymer passes through a curved tube having a defined inner diameter at at least three different injection rates to determine the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}×R^{0.22}), wherein De is the Deborah number, R is the curvature of the curved tube;
(c) fitting the x and y values into the equation

$$Log ( y ) = a {e}^{\frac{b}{log ( x )}}$$

to define the constants a and b; and
(d) fitting into the equation

$$Log ( y ) = a {e}^{\frac{b}{log ( x )}}$$

the defined values for the constants a and b along with field data for the variable x from the drag-reducing polymer passing through the tubing in the underground well to determine a corresponding value for y from which the friction pressure drop gradient of the drag-reducing polymer passing through the tubing in the underground well can be determined.

### BRIEF DESCRIPTION OF THE DRAWINGS

In order to more fully understand the drawings referred to in the detailed description of the present invention, a brief description of each drawing is presented, in which:

FIGS. 1(a), (b) and (c) demonstrate knowledge of the prior art that polymer elasticity has a role in reducing drag. In particular:

FIG. 1(a) depicts that near-wall vertical structures are closely related with production of Reynolds shear stress including quasi-stream wise vortices, low-speed streaks, hairpin vortices, vortex packets, etc.

FIG. 1(b) depicts that polymer structure in turbulent flow acts like elastic springs, giving large, positive spanwise countertorque and acting against rotation at the heads of downstream and secondary hairpin vortices.

FIG. 1(c) depicts that near-wall vertical structures in polymer solutions become weaker, thicker, longer and fewer.

FIG. 2(a) is a tubing loop used to evaluate the drag reduction of the friction reduction polymer inside a coiled tube.

FIG. 2(b) is a tubing loop used to evaluate the drag reduction of the friction reduction polymer through a straight tube.

FIG. 3 graphically demonstrates viscous and elastic modulus of a friction reduction polymer at increasing frequencies.

FIG. 4 presents the effect of increasing polymer concentration on the elastic modulus of a friction reduction polymer.

FIG. 5 presents the effect of increasing polymer concentration on the viscous modulus of a friction reduction polymer.

FIG. 6 illustrates the effect of injection rate on pressure drop reduction of a fluid containing a friction reduction polymer inside a coiled tubing.

FIG. 7 illustrates the effect of injection rate on friction reduction of a fluid containing a friction reduction polymer inside a coiled tube at room temperature.

FIG. 8 illustrates the effect of polymer concentration on pressure drop reduction of a fluid containing a friction reduction polymer inside a coiled tube at room temperature.

FIG. 9 is a graph showing an example of wave plot in semi-log scale of data from lab test results on a drag-reducing polymer in straight and curved tubes as compared to actual data from the use of straight tubes in a subterranean well in accordance with an embodiment of the present invention.

FIG. 10 is a graph showing the example results of FIG. 9 plotted on a log-log scale.

FIG. 11 depicts the correction of coiled tube curvature to make the data of the model defined herein to fit the field data and straight tubing.

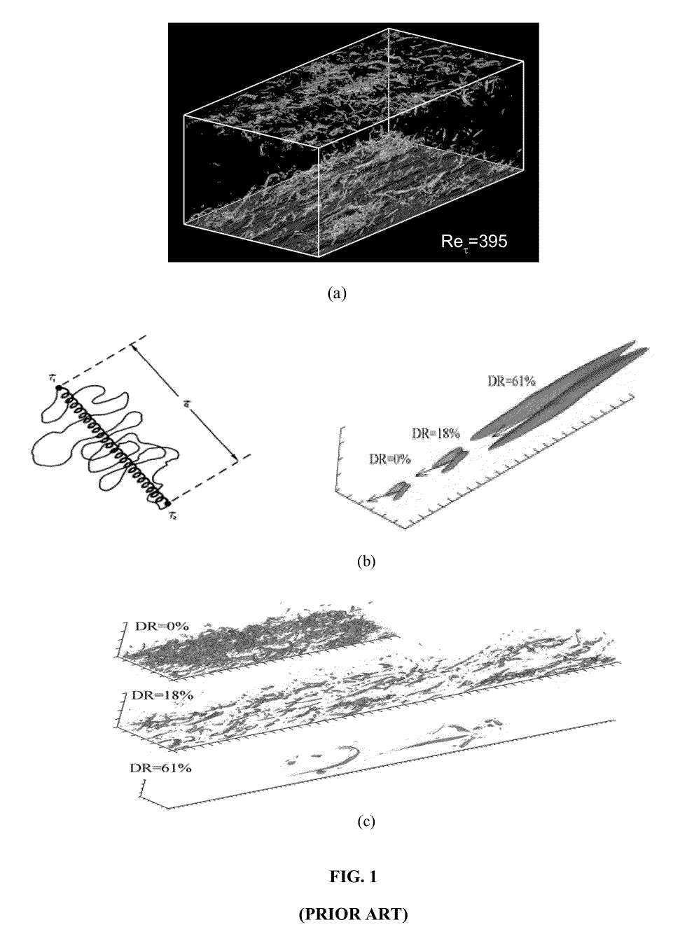

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent application or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments, common or similar elements are apparent from the figures and/or the description herein. The figures are not necessarily to scale and certain features and certain views of the figures may be shown exaggerated in scale or in schematic in the interest of clarity and conciseness.

As used herein and throughout various portions (and headings) of this patent application, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

The friction pressure drop caused by a friction reduction polymer may be accurately predicted by a mathematical model using the relaxation time of the friction reduction polymer, the diameter of the test tubing and the velocity of the fluid as it flows through the test tubing. An average error less than or equal to 0.045 psi/ft was observed when the mathematical model was used.

The procedure described herein may be used to scale up the lab test data to obtain the friction pressure of the friction reduction polymer under different field conditions. This model may be used to predict field performance from lab-scale straight tube experiments.

In a preferred embodiment, the procedure may be used to predict the behavior of a friction reduction polymer for use in a slickwater fracturing operation.

The model may be based on the characterization of the elasticity of the friction reduction polymer under turbulent conditions. In particular, the model is based on the relation between a log of Y axis representing the pressure drop gradient×diameter⁴×(1+De²)^{1.5}, wherein De is the Deborah number and the X axis represents relaxation time×velocity of the fluid flowing through the tubing, relaxation time refers to the time for the friction reduction polymer to adjust to applied stress or deformation.

Thus, the testing model is premised on the viscous effect of the friction reduction polymer in solution as well as the elasticity of the friction reduction polymer.

As a first step in the modeling, a series of tests are conducted to provide data that can then be used to predict field data. The lab tests include (i) small diameter flow loop tests with straight and/or curved tubes, and (ii) measurement tests for elastic modulus, G′, and viscous modulus, G″. For the small diameter flow loop tests, the tested polymer solution is injected through the tube(s) at different injection rates.

In a preferred embodiment, a minimum of three injection rates are tested. The pressure drop across a certain length of the subject tube is recorded as a function of injection rate. Based upon the tube diameter and injection rate, polymer solution velocity can be calculated. For the G′ and G″ measurements, the polymer solution is tested using an oscillatory rheometer. A frequency amplitude test is applied on the polymer solution and polymer relaxation time is measured.

For each data set, pressure drop, velocity of the fluid through the tubing, the inner diameter, ID, of the tested tube and the relaxation time of the friction reduction polymer are determined which are used to predict field data by plotting x=Relaxation Time×Velocity on the x-axis, y=Pressure Drop Gradient×Diameter⁴×(1+De²)^{1.5} on the y-axis for straight tubes and y=Pressure Drop Gradient×Diameter⁴×(1+De²)^{1.5}×R^{0.22} for coiled or curved tubes, wherein R is the curvature of the curved tube. The inclusion of the parameter R^{0.22} for curved tubes corrects the effects of curvature and existing secondary flow in the curved tubes, allowing accurate prediction of field data for straight tubes.

The x and y values for each lab test point may then be fit into Equation 1 to define the constants a and b:

$$Log ( y ) = a {e}^{\frac{b}{log ( x )}} \qquad ( I )$$

After determining a and b using lab data, Equation (I) can be used to calculate or predict friction pressure drop gradient for field (or other tube) data from term y by inserting actual measured values for x (Relaxation Time×Velocity). Likewise, measured values for y may be inserted into Equation (I) to calculate or predict field values for x.

The model described herein is based on the polymer elastic regime in turbulent flow. While the viscous regime is known to be dominant in laminar flow, drag reduction is observed in the turbulent regime and polymeric friction reducers are known to be only effective under turbulent flow conditions. The absence of drag reduction under laminar flow conditions is attributable to the low shear rate environment and the elastic component of the friction reduction polymer being significantly low.

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

### EXAMPLES

Two polyacrylamide based friction reducers were used in the Examples and are identified as Polymer A and Polymer B. The backbone of Polymer A is more susceptible to oilfield oxidizer breakers so its use reduces or eliminates formation damage as compared to Polymer B.

### Example 1

The rheology of the friction reducers was measured using a Thermo-Haake Rheostress 300 at room temperature. A Haake rheometer, which had a shear stress range from 10-5 to 900 Pa, and a frequency range from 10-5 to 100 Hz, was used with a parallel plate assembly and a gap of 1 mm for all measurements. Two types of experiments were conducted to determine the viscoelastic properties of the friction reducer: amplitude sweep test to define the linear viscoelastic region, and frequency sweep test to determine the shear-rate-dependent properties.

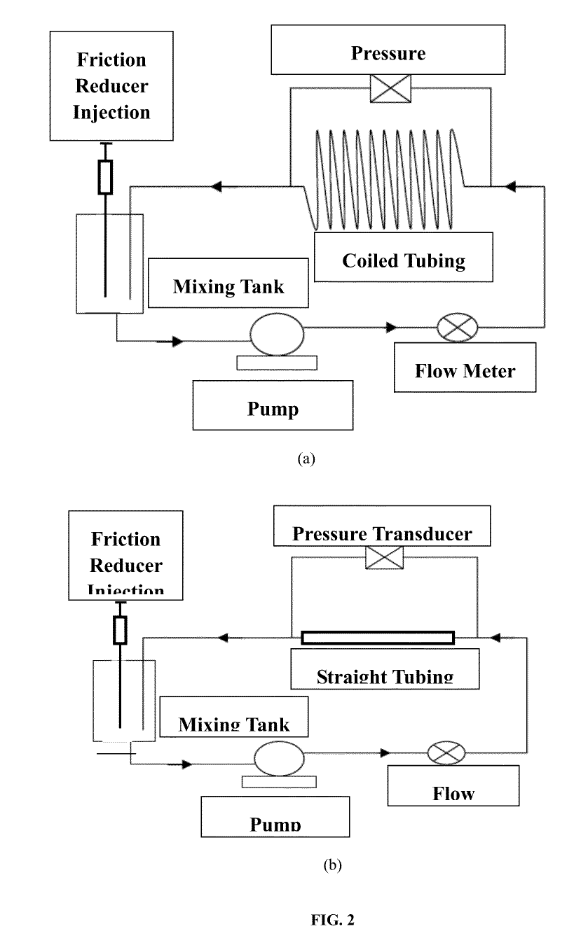

A coiled tubing loop was constructed as shown in FIG. 2(a) to evaluate the drag reduction of the friction reduction polymer inside the coiled tube. Pressure transducers may be connected to a computer to monitor and the pressure drop recorded across a core during the experiments every one second. A centrifuge pump with maximum allowable flow of 12 gal/min was used to circulate the polymer solution through the loop. FIG. 2(b) shows a tubing loop through straight-tube where the tube measured about 10 feet in length may be used to evaluate drag reduction inside the straight tube.

Table 1 shows the specifications of tubing used in the lab-scale flow loop testing setup. The coils were made by spooling different diameters of straight stainless steel tubing into drums with 2-ft diameter to yield a change in curvature ratio. The four coils can be interchanged through quick connections.

TABLE 1

| | Tube | Inner Diameter, | Total Length, | |
|---|---|---|---|---|
| NO. | Geometry | inch | ft | Curvature |
| 1 | Coiled Tube | 0.18 | 20 | 0.0075 |
| 2 | Coiled Tube | 0.245 | 20 | 0.0102 |
| 3 | Coiled Tube | 0.3198 | 50 | 0.013 |
| 4 | Coiled Tube | 0.43 | 20 | 0.0179 |
| 5 | Straight Tube | 0.677 | 10 | — |
| 6 | Straight Tube | 0.9 | 10 | — |
| 7 | Straight Tube | 1.162 | 10 | — |

The protocol for the friction reduction testing was as follow:
1. Water was circulated in the flow loop for about 1 minute to fill the tube at the desired injection rate.
2. The differential pressure drop across the tubing, fluid temperature, and flow rate (every second) were recorded as water was circulated in the flow loop for about 5 minutes.
3. Friction reducer emulsions were injected in the form of a slug directly into the bottom orifice of the tank to simulate on-the-fly addition. Water was circulated with the friction reducer for 5 minutes at the same flow rate used for the water alone.
4. The friction-reducing properties were determined by plotting pressure drop as a function of time. Flow rate and pressure drop values were first converted to Fanning friction factor and generalized Reynolds number. These two dimensionless groups were used in characterizing fluid flow through straight and coiled tubing. The following equations (in field units) were used in data analysis.

(i) Fanning friction factor, f is a dimensionless variable used to determine friction pressure gradient. It is defined by the following expression:

$$f = 25.8 [ \frac{\text{?} \text{?} \text{?}}{\text{?} \text{?} \text{?}} ]$$

$$\text{?} \text{indicates text missing or illegible when filed}$$

where, 1 is the length between pressure ports (ft); Δp is the pressure drop (psi); d is the internal diameter of straight or coiled tubing (in.); v is the fluid velocity (ft/sec); and p is the fluid density (lbm/gal).
   Average velocity, v in ft/sec was calculated from the following equation.

$$v = \frac{q}{\text{?} \text{?} \text{?} \text{?} \text{?} \text{?}}$$

$$\text{?} \text{indicates text missing or illegible when filed}$$

where, q is the flow rate (gal/min).

Fanning friction factor was plotted against Reynolds number, NRe.

$$N \text{?} = 928 [ \frac{\text{?} \text{?} \text{?}}{\text{?}} ]$$

$$\text{?} \text{indicates text missing or illegible when filed}$$

where μ is the fluid dynamic viscosity (cP).

Shear rate inside lab scale tubes and filed pipes was calculated as follows:

$$\overline{γ} = \frac{\text{?} \text{?}}{\text{?}}$$

$$\text{?} \text{indicates text missing or illegible when filed}$$

The shear rate was calculated from the applied frequency, fᵣ, using the equation:

$$\overline{γ} = \frac{\text{?} \text{?}}{\text{?}} \frac{\text{?} \text{?} \text{?}}{\text{?}}$$

$$\text{?} \text{indicates text missing or illegible when filed}$$

where γ̅ is the shear rate, s⁻¹; r is the radius of plate, mm; fr is the frequency, Hz; and h is the gap between the parallel plates, mm.
   The Deborah number, a dimensionless term to quantify the viscoelastic behavior of the fluid, was calculated as:

$$D \text{?} = \text{?} λ = \overline{γ} λ$$

$$\text{?} \text{indicates text missing or illegible when filed}$$

where γ̅ is the shear rate, s⁻¹; fr is the frequency, Hz; and [symbol] is the relaxation time, s.

Rheology. Rheology measurements were undertaken for Polymer A and Polymer B. A stress sweep test confirmed that the applied stress value of 0.1 Pa was within the linear viscoelastic limit. Therefore, a sinusoidal shear stress of 0.1 Pa was applied at an oscillation frequency range of 10-2 Hz to 10 Hz to determine frequency limits of elastic or viscous regimes. FIG. 3 shows the elastic modulus (G′) and the viscous modulus (G″) as a function of frequency for Polymer A at a concentration of 0.5 gpt and room temperature. As the frequency increased from 10-2 to 10 Hz, the G′ increased from 10-5 to 0.2 Pa and G″ increased from 1.5×10-3 Pa to 0.1 Pa. The G′ and G″ crossover point was achieved at a frequency of 2.05 Hz, where both (G′ and G″) had the same value. Polymer A at concentration of 0.5 gpt and at a frequency less than 2.05 Hz behaved as a viscous fluid (viscous regime), where the viscous modulus was dominant over the elastic modulus. However, at frequency higher than 2.05 Hz, Polymer A behaved as an elastic material (elastic regime), where the elastic modulus was dominant over the viscous modulus, FIG. 3. Thus, elasticity is demonstrated as having been increased with increasing frequency and/or shear rate.

Relaxation time is defined as the inverse of the frequency value at the G′ and G″ crossover point. Table 2 shows the values of relaxation time for Polymers A and B at all tested concentrations.

TABLE 2

| | Polymer Concentration, | |
|---|---|---|
| Polymer Type | gpt | Relaxation time, s |
| A | 0.5 | 0.155 |
| | 0.75 | 0.154 |
| | 1 | 0.152 |
| B | 0.5 | 0.155 |
| | 0.75 | 0.154 |
| | 1 | 0.154 |

Based on Table 2, relaxation times for Polymer A and Polymer B are demonstrated as being independent of concentration. Since the chemistry of both polymers was nearly identical, there was no difference between the relaxation time of Polymer A and B.

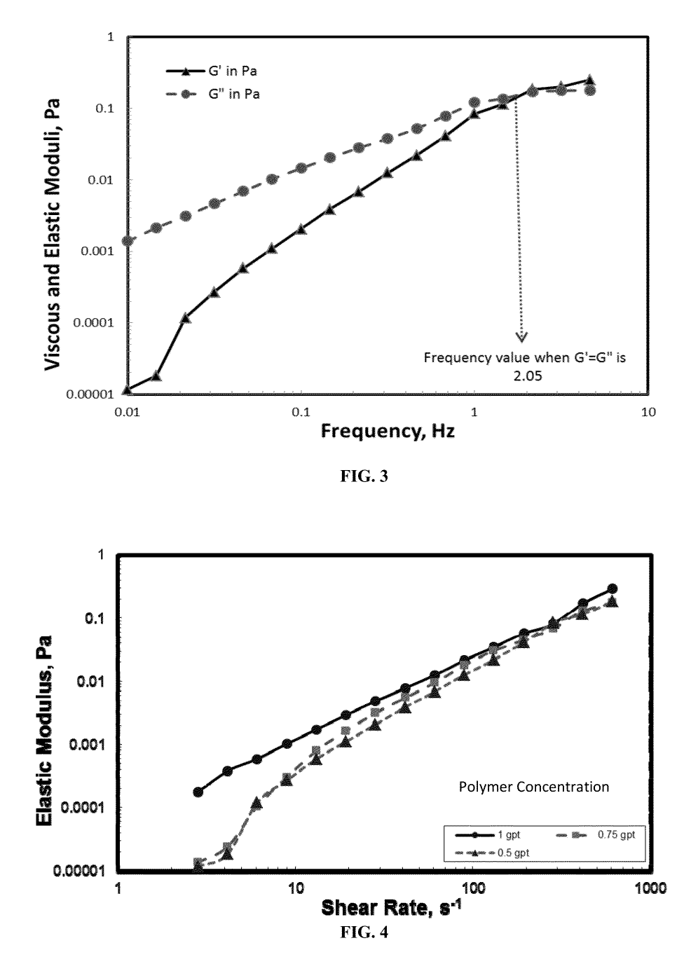

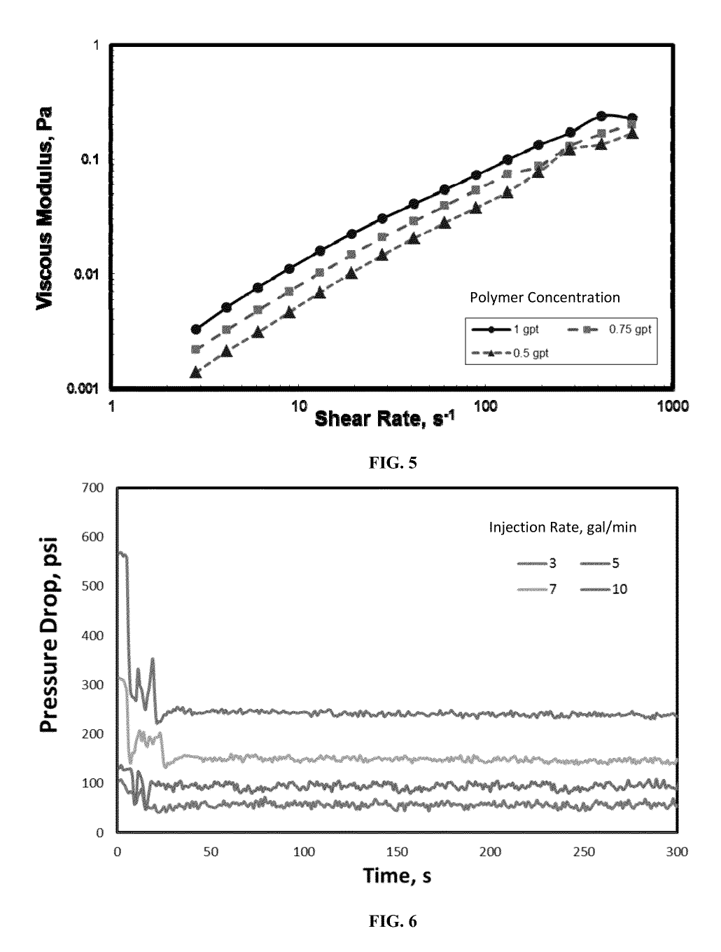

FIGS. 4 and 5 present the effect of increasing polymer concentration on the performance of G′ and G″ as a function of shear rate, respectively. These figures demonstrate that increasing the polymer concentration increases the values of G′ and G″. However, G″ increased slightly more than G′ with increasing polymer concentration.

Friction Reduction. The phenomenon of friction reduction of Polymers A and B under turbulent flow conditions was evaluated at different injection rates, pipe diameters, and polymer concentrations using the lab-scale flow loop shown in FIG. 2. FIG. 6 shows the reduction in the pressure drop when 1 gpt of Polymer A was introduced to the system at different injection rates. At an injection rate of 10 gal/min, the pressure drop of water flow inside 0.245-in. ID tube was nearly 567 psi. After Polymer A was injected, the pressure drop decreased to 243 psi within 10 second. This demonstrates the time needed to invert the water-in-oil emulsion to oil-in-water and allow the polymer to completely hydrate.

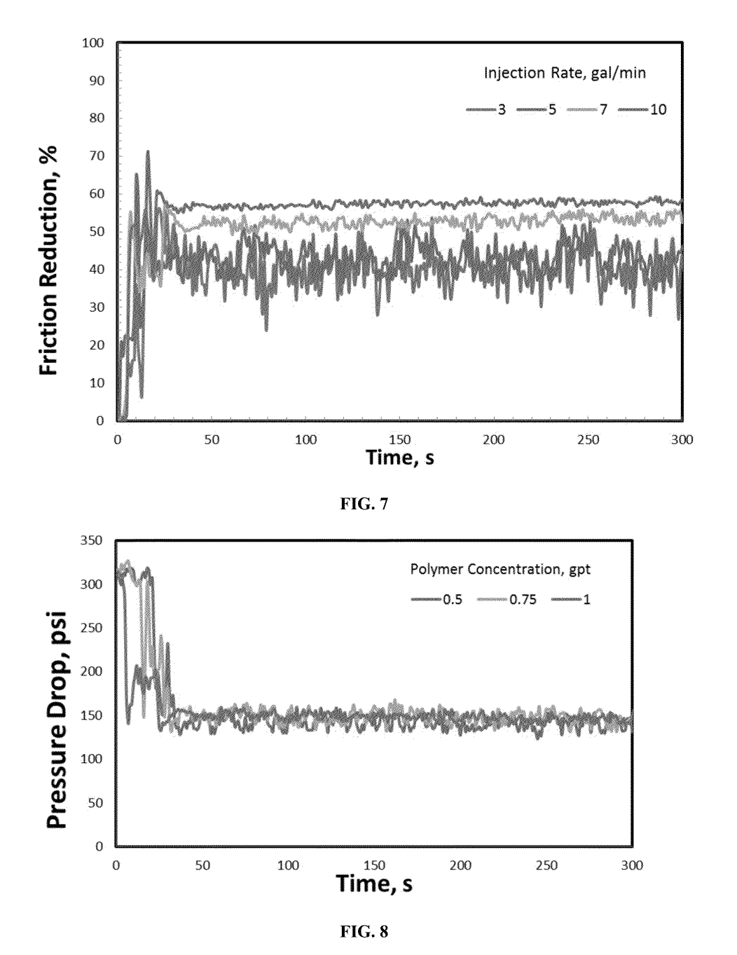

FIG. 7 shows the effect of the injection rate on the friction reduction using Polymer A at 1 gpt concentration and demonstrates that increasing the injection rate improved the friction reduction of Polymer A. This observation agrees with the rheology performance of Polymer A, where increasing the shear rate by increasing the injection rate enhanced the elastic characterization of Polymer A, which in turn enhanced the ability of Polymer A to overcome the turbulent flow vortices. Therefore, at higher injection rate, a higher friction reduction was observed.

FIG. 8 shows the effect of polymer concentration on the pressure drop performance of Polymer A and demonstrates that polymer concentration had no effect on the friction reduction. Based on Table 2, it can be determined that relaxation times for Polymers A and B were independent of polymer concentration and is supportive of the conclusion that the relaxation time of the polymer solution is essentially associated with the transport of the elastic energy. The polymer stores the elastic energy from the flow very near the wall and then releases it there when the relaxation time is short, showing no drag reduction. However, when the relaxation time is long enough, the elastic energy stored in the very near-wall region is transported and released in the buffer and log layers, significantly reducing drag.

### Example 3

Friction pressure of Polymer A and Polymer B were tested under different conditions using straight and coiled tubes. For the small-diameter flow loop test, the tested polymer solution was injected through the coiled or straight tube at different injection rates (at least three points are needed). The pressure drop across a certain length was recorded as a function of injection rate. Based on the tube diameter and injection rate, the polymer solution velocity was calculated, using the equation above. For G′ and G″ measurements, the polymer solution was tested using an oscillatory rheometer. A frequency amplitude test was applied to the polymer solution, and polymer relaxation time was measured. The testing provided data about the pressure drop, velocity, tube diameter, and relaxation time. These four parameters were then used to predict the field data by plotting on log-linear scale where:

the X axis was linear scale: relaxation time×velocity;

for straight tubes, the Y axis (log scale) was pressure drop gradient×diameter⁴×(1+De²)^{1.5}, where De is the Deborah number.

for coiled tubes, the Y axis (log scale) was pressure drop gradient×diameter⁴×(1+De2)1.5×R^{0.22}, where R is the coiled tubing curvature ratio.

the lab test point will fit the form of the equation:

$$Log ( y ) = a {e}^{\frac{b}{log ( x )}} \qquad ( I )$$

and the constants “a” and “b” defined

after determining the constants “a” and “b” from the lab data, Eq. (I) can be used directly to calculate the pressure drop for any field or other tube data.

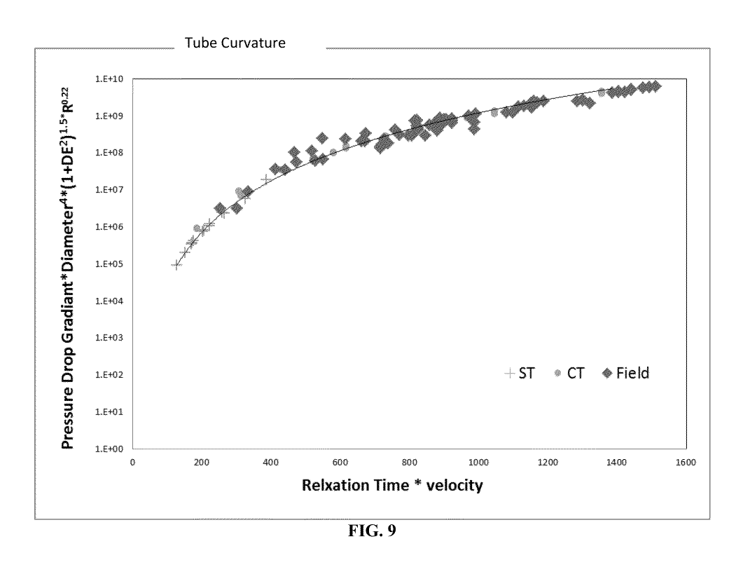

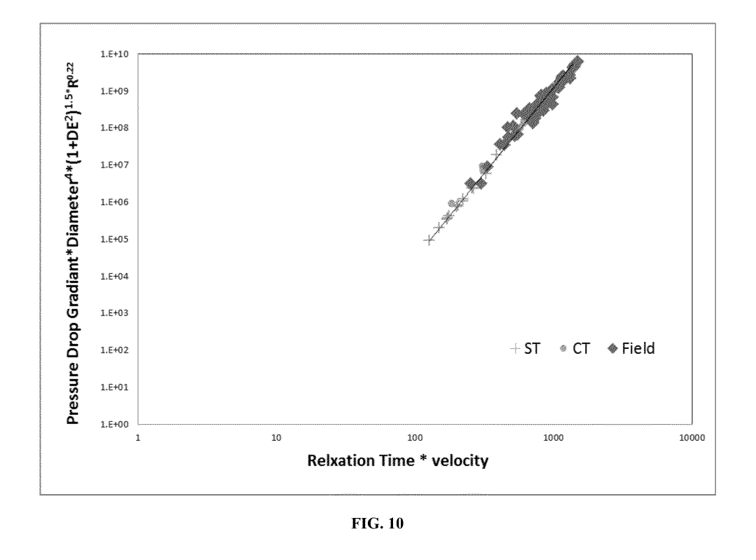

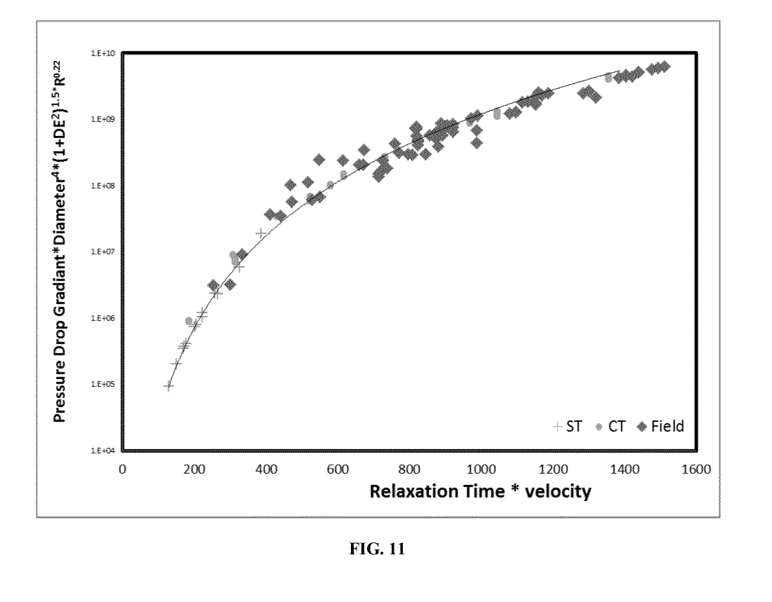

The log of Y axis representing the pressure drop gradient×diameter⁴×(1+De²)^{1.5}, wherein De is the Deborah number and the X axis representing relaxation time×velocity of the fluid flowing through the tubing was obtained and was used to predict field performance. FIGS. 9 and 10 plot the results of testing in accordance with this embodiment of the present disclosure of drag-reducing polymers in different diameter straight and (ST) curved tubes (CT) at multiple different injection rates as compared to actual field data taken with straight tubes. For example, lab tests were conducted on coiled tubing at 10 different injection rates. (It should be noted that while the formula shown on the y-axis includes the parameter R^{0.22}, that parameter is not part of the y calculation for straight tubes, as described above.) The data obtained from the lab-scale straight tube (ID: 0.677 to 1.162 in.) and field applications (ID: 3.826 to 6.276 in.) follow the same curvature trend. This allows the accurate prediction of or correlation to field data. Therefore, the lab-scale straight tubes may be used to create this trend, which will be used for predict the friction pressure drop for field applications.

Another benefit from this trend is that it corrects for the curvature effect that exists in the data obtained from lab-scale coiled tube experiments, and uses the correction to predict the field data. The coiled tube curvature was corrected by multiplying the Y axis by R^{0.22}, where R is the coiled tubing curvature ratio. FIG. 11 shows the corrected lab-scale coiled tube data can fit the obtained trend for use in predicting field friction reduction performance.

The experimental results showed that elastic and viscous moduli of the drag-reducing polymers increase by increasing the polymer concentration. However, certain rheological characteristics did not change upon a change in the polymer concentration, leading to no significant effect on friction pressure drop gradient at different polymer concentrations. The elastic modulus of the polymer solution was increased by increasing the shear rate. Therefore, at the same diameter, a higher reduction in friction pressure drop gradient was obtained by increasing the injection rate.

An error analysis was conducted and field data for friction pressure drop gradient was used to verify the exemplary methodology. An average error of 0.045 psi/ft was observed. The error analysis results showed a reasonable error range, as shown in Table 3.

TABLE 3

| | | | | | | Field | |
|---|---|---|---|---|---|---|---|
| | | Straight | Straight | Straight | | Straight | |
| | | Tube | Tube | Tube | Curved | Tube | |
| | Straight Tube | (ID) | (ID) | (ID) | Tube | (ID) | |
| | Average | 0.677″ | 0.900″ | 1.167″ | 0.220″ | 3.896″-6.276″ | |
| Min | 0.000 | 0.001 | 0.000 | 0.000 | 0.001 | 0.001 | psi/ft |
| Max | 0.218 | 0.233 | 0.304 | 0.270 | 0.207 | 0.207 | psi/ft |
| Average | 0.045 | 0.080 | 0.115 | 0.100 | 0.049 | 0.042 | psi/ft |
| ST Dev | 0.043 | 0.068 | 0.096 | 0.081 | 0.042 | 0.037 | psi/ft |

Table 3 shows the error analysis in predicting the field data from coiled and straight tubes: When using all data obtained from straight tubes, an average error of 0.045 psi/ft and standard deviation of 0.043 psi/ft were obtained. When using all data obtained from coiled tubes, an average error of 0.049 psi/ft and standard deviation of 0.042 psi/ft were obtained. There was no significant impact on the error analysis when using the data obtained from coiled tubes (after curvature correction) or straight tubes. Increasing the number of lab data point reduce the error observed from the prior art models.

Use of the model described herein employs relaxation time which is a critical property in defining drag reduction. Experimental results further show that elastic and viscous moduli increased by increasing the polymer concentration; however, relaxation time was independent of the polymer concentration. This led to no significant effect on the pressure drop reduction at different polymer concentrations. Further, since elastic modulus of the solution containing the friction reduction polymer increases with shear rate, at the same diameter, a higher pressure drop reduction may be obtained by increasing the injection rate. Further, the Examples demonstrate that the onset drag of reduction for friction reduction polymer in inside straight tubes (ST) is lower than the onset of drag of reduction in coiled tubes. The drag reduction envelope further confirmed that increasing injection rate may be the main parameter affecting drag reduction. The Examples illustrate that by combining lab small-scale testing and new mathematical procedures, an accurate prediction for field friction pressure drop was achieved.

Preferred embodiments of the present disclosure thus offer advantages over the prior art and are well adapted to carry out one or more of the objects of this disclosure. However, the present invention does not require each of the components and acts described above and are in no way limited to the above-described embodiments, methods of operation or variables. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that are provided in or apparent from the description above or claimed herein, and any other methods which may fall within the scope of the appended claims, may be performed in any desired suitable order and are not necessarily limited to any sequence described herein or as may be listed in the appended claims. Further, the methods of the present invention do not necessarily require use of the particular components shown and described herein, but are equally applicable with any other suitable structure, form and configuration of components.

While exemplary embodiments of the invention have been shown and described, many variations, modifications and/or changes of the system, apparatus and methods of the present invention, such as in the components, details of testing and methodology, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

What is claimed is:

1. A method of determining the friction pressure drop gradient of at least one drag-reducing polymer passing through a tubing in an underground well, the method comprising:
(a) conducting diameter flow loop tests and determining elastic modulus, G′, and viscous modulus, G″, of at least one drag-reducing polymer as the polymer passes through a straight tube having a defined inner diameter at at least three different injection rates and then determining the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}), wherein De is the Deborah number; and
(c) plotting each x, y data point on a graph where the x-axis represents (Relaxation Time×Velocity) and the y-axis represents (Pressure Drop Gradient×Diameter⁴×(1+De²)^{1.5}), wherein the curve formed by the plotted data approximates the x and y data for the drag-reducing polymer as it passes through the tubing in the underground well.

2. The method of claim 1, wherein the drag-reducing polymer is used in a slickwater fracturing operation.

3. A method of allowing the accurate prediction of the friction pressure drop gradient of at least one drag-reducing polymer passing through a straight tubing in an underground well based upon lab results of testing conducted on curved tubing, the method comprising:
(a) conducting small diameter flow loop tests and making elastic modulus, G′, and viscous modulus, G″, measurements of at least one drag-reducing polymer as the polymer passes through a curved tube having a defined inner diameter at at least three different injection rates to determine the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}×R^{0.22}), wherein De is the Deborah number, R is the curvature of the curved tube; and
(c) plotting each x, y data point on a graph where the x-axis represents (Relaxation Time×Velocity) and the y-axis represents (Pressure Drop Gradient×Diameter⁴×(1+De²)^{1.5}×R^{0.22})wherein the curve formed by the plotted data approximates the x and y data for the drag-reducing polymer as it passes through the tubing in the underground well.

4. A method of determining the friction pressure drop gradient of at least one drag-reducing polymer passing through a tubing in an underground well, the method comprising:
(a) conducting diameter flow loop tests and making elastic modulus, G′, and viscous modulus, G″, measurements of at least one drag-reducing polymer as the polymer passes through a straight tube having a defined inner diameter at at least three different injection rates to determine the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}), wherein De is the Deborah number;
(c) fitting the x and y values into the equation
$$Log ( y ) = a {e}^{\frac{b}{log ( x )}}$$
to define the constants a and b; and
(d) fitting into the equation
$$Log ( y ) = a {e}^{\frac{b}{log ( x )}}$$
the defined values for the constants a and b along with field data for the variable x from the drag-reducing polymer passing through the tubing in the underground well to determine a corresponding value for y from which the friction pressure drop gradient of the drag-reducing polymer passing through the tubing in the underground well can be determined.

5. A method of determining the friction pressure drop gradient of at least one drag-reducing polymer passing through a tubing in an underground well, the method comprising:
(a) conducting diameter flow loop tests and making elastic modulus, G′, and viscous modulus, G″, measurements of at least one drag-reducing polymer as the polymer passes through a curved tube having a defined inner diameter at at least three different injection rates to determine the pressure drop, velocity and relaxation time of the drag-reducing polymer across a length of the tube at each injection rate;
(b) for each injection rate data set, calculating the variables x=(Relaxation Time×Velocity) and y=(Pressure Drop Gradient×Diameter⁴×(1+De²)^{1.5}×R^{0.22}), wherein De is the Deborah number, R is the curvature of the curved tube;
(c) fitting the x and y values into the equation
$$Log ( y ) = a {e}^{\frac{b}{log ( x )}}$$
to define the constants a and b; and
(d) fitting into the equation
$$Log ( y ) = a {e}^{\frac{b}{log ( x )}}$$
the defined values for the constants a and b along with field data for the variable x from the drag-reducing polymer passing through the tubing in the underground well to determine a corresponding value for y from which the friction pressure drop gradient of the drag-reducing polymer passing through the tubing in the underground well can be determined.
